(19) United States
(12) Patent Application Publication
(10) Pub. No.: US 2025/0342434 A1
(43) Pub. Date: Nov. 6, 2025

(54) ITEM TRACKING SYSTEM

(71) Applicant: Global Smart Logic Pty Ltd, West Mackay, Queensland (AU)

(72) Inventors: Jim Whelan, West Mackay, Queensland (AU); Paul Heel, West Mackay, Queensland (AU)

(21) Appl. No.: 18/860,790

(22) PCT Filed: Apr. 28, 2023
(86) PCT No.: PCT/AU2023/050351

§ 371 Date: Oct. 28, 2024

(30) Foreign Application Priority Data
Apr. 28, 2022 (AU) 2022901122

(51) Int. Cl. G06Q 10/087; G06K 7/10; G06K 19/07

(52) U.S. Cl. CPC G06Q 10/087; G06K 7/10366; G06K 19/0723

(57) ABSTRACT

Embodiments relate to tracking items shipped and/or stored in aggregate where the aggregate may obscure labels used to identify the items. For example a pallet-load of batteries tagged with RFID labels. An embodiment provides a method and system for tracking a geographical location of a designated item, the method comprising: collecting a plurality of items including the designated item to form an aggregate, wherein each of the plurality of items, including the designated item, has a corresponding item label, and the aggregate is formed in such way to obscure one or more of the item labels; applying a group label to the aggregate; reading the group label with a first scanner; associating a first location with the first scanner; ascribing the first location to the group label; and ascribing the first location to the designated item.

### TECHNICAL FIELD

Embodiments relate to a system and corresponding method for tracking items, and in particular, for tracking movement of items between different geographic locations.

### BACKGROUND

It is known to track items in a commercial, storage or other environment using labels such as barcodes, QR codes, RFID tags or similar.

In certain applications, particularly where the items are stacked together or held in proximity to one another the labels may be obscured or otherwise unreadable. This may lead to false or indeterminate label reads.

In an environment where there are a large number of tags, searching for a particular item by looking for a particular tag can be a time-consuming, as well as network-and processor-intensive, task.

### SUMMARY OF THE DISCLOSURE

An embodiment provides a method for tracking a geographical location of a designated item, the method comprising:
collecting a plurality of items including the designated item to form an aggregate, wherein each of the plurality of items, including the designated item, has a corresponding item label, and the aggregate is formed in such way to obscure one or more of the item labels;
applying a group label to the aggregate;
reading the group label with a first scanner;
associating a first location with the first scanner;
ascribing the first location to the group label; and
ascribing the first location to the designated item.

The step of ascribing the first location to the designated item may occur without reading any of the item labels. All of the above steps may occur without reading any of the item labels of the plurality of items forming the aggregate.

The one or more of the item labels may be an RFID tag. The group label may be an RFID tag. Each of the item labels and the group label may be RFID tags.

The method may further comprise associating a second location to a second scanner; scanning the group label with the second scanner and ascribing the second location to the designated item. This may be done by ascribing the second location to the group label in place of the first location. Alternatively a second group label corresponding to the second location may be applied to the aggregate when the aggregate is moved.

The method may further comprise removing a moved item from the aggregate; scanning an item label associated with the moved item and updating information associated with the group label. Updating information associated with the group label may occur automatically the item label associated with the moved item is updated.

The method may further comprise the step of updating information associated with a further group label after moving a moved item.

A group label may be generated independently of any or all of the item labels.

Each item label and each group label may have label information associated therewith.

The label information may comprise one or more of the following: owner identification, label type, item type, creation date, location designator and serial number.

The step of ascribing the first location to the group label and/or the step of ascribing the first location to the designated item may comprise updating a location designator for label information associated with the group label and/or the designated item.

The step of moving the moved item may comprise updating the location descriptor for a label associated with the moved item.

The label information may be data stored in or on the label associated with the item. The label may be affixed to the item.

Where the label information comprises data stored in or on the label, updating the label information may comprise storing new data in or on the label.

When scanning a label, the label type may be determined from the label information and the scanner may determine whether the label type matches a sought label type.

The step of collecting a plurality of items including the designated item to form an aggregate may include the step of disabling each of the item labels of each of the plurality of items.

The information associated with an item may further comprise an active status. The active status may be set to “active” or “inactive”. The status may indicate whether a corresponding item is an active or inactive item of stock.

Associating a scanner with a corresponding location may comprise locating the scanner at the corresponding location. The scanner may be located at the corresponding location so that it is difficult or manually impossible to move the scanner from the corresponding location. For example, the scanner may be tethered to an anchor where the anchor is located at the corresponding location.

A further embodiment extends to a system for tracking a geographical location of a designated item, the system comprising:
a plurality of items including the designated item collected to form an aggregate, wherein each of the plurality of items, including the designated item, has a corresponding item label, and the aggregate is formed in such way to obscure one or more of the item labels;
a group label applied to the aggregate;
a first scanner associated with a first location;
a processor connected to memory and machine readable instructions loaded to the memory to cause the processor to:
   read the group label with the first scanner;
   associate a first location with the first scanner;
   ascribe the first location to the group label; and
   ascribe the first location to the designated item.

The step of ascribing the first location to the designated item may occur without reading any of the item labels. All of the above steps may occur without reading any of the item labels of the plurality of items forming the aggregate.

The system may further comprise a second scanner associated with a second location and the processor may be adapted to ascribe the second location to the designated item when the group label is scanned with the second scanner.

The system may be adapted to update information associated with the group label when a moved item is removed from the aggregate and an item label associated with the moved item is scanned with a scanner.

The system may be adapted to update information associated with a further group label after moving the moved item.

Each item label and each group label may have label information associated therewith.

The label information may comprise one or more of the following: owner identification, label type, item type, creation date, location designator and serial number.

The step of ascribing the first location to the group label and/or the step of ascribing the first location to the designated item may comprise updating a location designator for label information associated with the group label and/or the designated item.

The step of moving the moved item may comprise updating the location descriptor for a label associated with the moved item.

The label information may be data stored in or on the label associated with the item. The label may be affixed to the item.

Where the label information comprises data stored in or on the label, updating the label information may comprise storing new data in or on the label.

When scanning a label, the label type may be determined from the label information and the scanner may determine whether the label type matches a sought label type.

The step of collecting a plurality of items including the designated item to form an aggregate may include the step of disabling each of the item labels of each of the plurality of items, or reducing scanner power to discriminate or target closer proximity tags.

The information associated with an item may further comprise an active status. The active status may be set to “active” or “inactive”.

A further embodiment extends to a method of seeking a designated item among a plurality of items wherein each item, including the designated item, has a corresponding item label, each item label having information stored thereon wherein the information stored on each label identifies the type of label and/or the type of item, the method comprising:
providing a first scanner and associating a first location with the first scanner
reading a plurality of labels with the first scanner;
wherein the scanner is adapted to determine the type of label and/or the type of item based on reading the corresponding label and, only if the type of label and/or the type of item matches the type of label and/or the type of label of the designated item, querying a remote server to determine whether the item or label matches the designated item.

The designated item may be included in an aggregate of a plurality of items, wherein the plurality items has a group label associated therewith. The item label corresponding to the designated item may be disabled while the designated item forms part of the aggregate. The item label may be obscured by items in the aggregate.

Where the item forms part of an aggregate, the method may comprise the steps of programing the scanner to seek a group label and querying the remote server when the scanner determines that a read label is a group label and not querying the remote server when the scanner determines that the read label is not a group label or is an item label.

Where the item does not form part of an aggregate, the method may comprise the steps of programing the scanner to seek an item type and querying the remote server when the scanner determines that a read label corresponds to a specified item type and not querying the remote server when the scanner determines that the read label does not correspond to the specified item type.

### DESCRIPTION OF THE DRAWINGS

Embodiments are herein described, with reference to the accompanying drawings in which:

FIG. 1 illustrates a battery with an RFID tag attached used in an embodiment;

FIG. 2 illustrates a stack of batteries used in an embodiment;

FIG. 3 illustrates data fields used with an RFID for use with an embodiment;

FIG. 4 is a schematic illustration of a store and associated warehouse with an implementation of an embodiment;

FIG. 5 is a schematic illustration of a system according to an embodiment;

FIG. 6 is a process diagram of aspects of an embodiments;

FIG. 7 is a process diagram of aspects of an embodiments;

FIG. 8 is a process diagram of aspects of an embodiments;

FIG. 9 is a process diagram of aspects of an embodiments; and

FIG. 10 is a process diagram of aspects of an embodiments.

### DETAILED DESCRIPTION OF SPECIFIC EMBODIMENT

Aspects of an embodiment concern tracking the location of an item in a storage, sales or other environment. In general, embodiments may be used to locate an item. Aspects of embodiments concern applying labels to items. A specific embodiment concerns RFID labels but other labels may be used instead or as well as RFID tags. For example, QR codes or barcodes could be used instead.

Items are often moved and stored in bulk. In particular, an aggregate of items may be formed by grouping a plurality of items together. For example, a plurality of items may be collected in a stack and transported on a palette. In a further example, a plurality of items may be stored in close proximity to one another on a shelf or other storage location in a warehouse, or for display in a sales environment.

When items are stacked together the labels may be obscured. This is a known problem with labels such as barcodes and QR codes which rely on line-of-sight between the label and the scanner. This is a less well-known issue with RFID tags and other labels which rely on proximity to a scanner rather than line-of-sight. However, it has been found that certain items may obscure RFID tags, for example, when stacked or brought into proximity with one another. It has been found that where the items contain a large metal component then a stack of items may act as a Faraday cage to shield or otherwise interfere with the interaction between the scanner and the label. In an embodiment, the items are batteries and it has been found that a stack of batteries in close proximity to one another interfere with the ability of a scanner to successfully read the RFID tags for all items. In particular, this may significantly reduce the effective range of the scanner when reading the item RFID tags which may result in incorrect or missed readings.

In order to track a plurality of items collected into an aggregate, embodiments make use of a group label. A group label, in certain embodiments, is a single label which is applied to the aggregate. It may then be possible to track all items in the aggregate by tracking a location of the group label without having to read any of the item labels.

When the labels are read/write RFID tags, the step of forming an aggregate may comprise disabling each of the RFID tags of the items in the aggregate. This may help to avoid false reads.

In certain embodiments, the labels are physically affixed to the item and the aggregate. By affixing the labels to the items or the aggregate, the location of the label corresponds to the location of the item or the aggregate. This may make it easier to track a location of an item.

A label scanner may be mobile and may be moved from place to place. Therefore, in certain embodiments, to help ensure that the location of an item may be more accurately determined, a scanner is associated with a certain location. For example, a scanner may be associated with a warehouse or a shop. In this instance, when a label is read using that scanner, the location of the item or items corresponding to the used location will then be the location of the scanner.

Associating a location with a scanner may be done by physically restricting the location of a scanner by, for example, tethering the scanner to that location by, for example, having an anchor which is permanently attached to a fixture of that location and tethering the scanner to the location. In this manner, the scanner is permitted relative movement about the location while movement away from that location is restricted.

For example, if the location is a warehouse, the scanner for the warehouse may be tethered by a cord to a shelf in a manner so that a user is not able to easily disengage the scanner from the tether or the tether from the shelf. Then, that scanner will be associated with the shelf in the warehouse and it is then known that any label scanned by that scanner is unequivocally located at the associated shelf in the warehouse.

In a further embodiment, the location may be associated with the scanner by requiring a user to log in to the scanner and associating the location with a user's role. For example, if that user has been assigned to work in a specific warehouse, then the location associated with that scanner is the location of the warehouse. In this manner a scanner may be assigned to a user, and the location associated with the scanner changed depending on the role assigned to the user.

Alternatively, or in addition, the location of a scanner may be restricted by operator conditioning, ensuring that an operator of a scanner only uses that scanner in a designated location.

When an item or an aggregate is moved from one location to a second location, a second scanner at the second location may be used to read the corresponding label. When the second scanner is associated with the second location, the location of the item or the aggregate can be updated. Alternatively, a group label may be associated with only one location, in which case, moving the aggregate from a first location to a second location may comprise applying a second group label to the aggregate, where in the second location is associated with the second group label.

Each label may have label information associated therewith. For example, where the labels are read/write or write once, read many times then the label information may be stored on the label. Alternatively, or in addition, the label information may be stored remotely from the label, for example in a database administered by a remote server.

The label information may comprise one or more of the following: owner identification, label type, creation date, location designator and serial number.

The location designator may be used to locate an item (whether stored in an aggregate, or not). In particular, if the label information is stored at a remote server, then the server may be queried to determine the location of the item. The specified location may then be searched to find the item. By defining small locations (relative to the size of the item, the total number of items and the storage space concerned, for example), it may be possible to rapidly identify the item.

The location designator may correspond to a geographical location. A code may be used for the location designator and it may not be possible to determine an actual physical location from the code alone. In an alternate embodiment other geographical indications may be use as well as, or instead as a code, for the location designator. In an embodiment, the location designator includes an address and/or co-ordinates.

Furthermore, with labels which are scanned by proximity such as RFID tags, the scanner may be programmed to locate the item by determining a signal strength of the label corresponding to the item, thereby prompting a user to move in a direction which strengthens the signal. Such a locate function may be advantageously used with embodiments where a general location may be provided by the label information, and then the item located in that general location by feedback based on signal strength.

Advantageously, such a locate function may be used in conjunction with the aforementioned location associated with the scanner.

A label or item type be used to avoid querying a central database with each label scanned. For example, if a scanner is searching for a particular item then the scanner may determine the label type corresponding to the item (or aggregate, as appropriate). When scanning labels, the scanner is then able to query the central database for only those labels which match the label type concerned. This may significantly speed up the scanning process by avoiding queries to the central database.

A system according to an embodiment may also implement a local audit function (also referred to as a “desktop audit function”), where a location is selected and the quantity expected via a stock listing is compared against the sum count of group and individual labels (such as master, pallet and individual tags) seen, effectively identifying stock anomalies before staff recognise them. This may also enables relatively fast bulk stock checks, because we only group labels in a location are scanned. A few dozen labels may represent thousands of stock items.

In an embodiment, once stock is received and tagged within the system, it may not be moved, sold, shipped or stock-checked unless it is uniquely tagged, location-set and validated. Any logistics process (move, transfer, deliver, sale or return) may be strictly controlled via the system, and the location code is amended accordingly. Group labels may be constantly validated and updated as individual tags are ‘seen elsewhere’ in the logistics chain.

The information associated with an item may further comprise an active status which may be set to “active” or “inactive”. By using an active status, items may be included or excluded from consideration by the system. Where the label information is stored on the label, this may reduce networking and processing, avoiding the need to query a central database with information relating to labels which have been set as inactive.

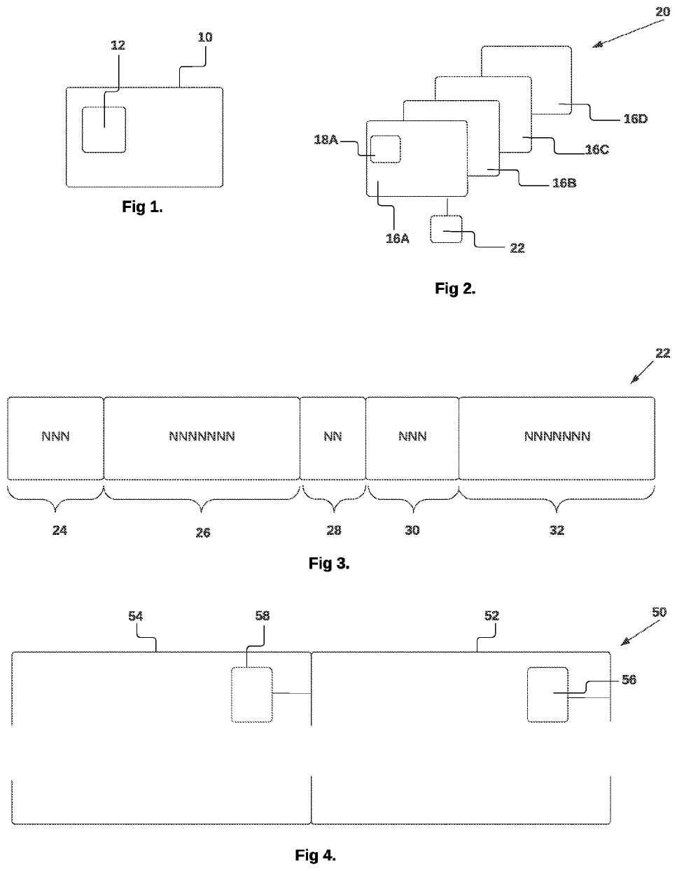

FIG. 1 illustrates an item 10, which in this embodiment is a battery with a label 12 affixed thereto. In this embodiment, the label 12 is a radio frequency identity (RFID) tag which may be read and written to.

As described in detail below, embodiments relate to the formation of aggregates with a plurality of item. FIG. 2 illustrates an aggregate 20 comprised of a plurality of batteries. The aggregate 20 shown comprises four batteries 16A, 16B, 16C and 16D. Each of the batteries here are of the same type, but it is to be realised that the batteries may not be of the same type, and that further embodiments are applicable to other item types.

Each of the batteries 16A, 16B, 16C and 16D have a corresponding label in the form of a read/write RFID tag. Only the RFID tag 18A affixed to battery 16A is shown; the tags of the other batteries are obscured. A group tag 22 is affixed to the aggregate 20. The group tag 22 is also an RFID tag and be affixed to the aggregate in a known manner. For example, particularly where the aggregate is moved on a palette, for example, by a forklift, the aggregate may be wrapped, and the group tag affixed to the outside of the wrap.

It is to be realised that a physical binding of a plurality of items is not the only way to form an aggregate and many other ways may be used instead. For example a stack of items in a shop or on a shelf in a warehouse may be considered an agglomerate. In further examples, all the items at a particular location such as a truck or a warehouse may be considered an agglomerate.

FIG. 3 illustrates the label information 22 associated with labels of embodiments. The label information 22 in this embodiment is stored as an alphanumeric code split by character numbering along the code into different fields with corresponding meaning. Where, as in the embodiment illustrated in FIGS. 1 and 2 and described above, the labels are writable RFID tags, the label information 22 is stored on the tag. In further embodiments, the label information may be stored remote from the label in which case a lookup operation is performed based on information provided by the tag (for example a URL provided by a QR code) and the corresponding label information is retrieved.

As illustrated in FIG. 3, the label information is split into fields 24, 26, 28, 30 and 32.

Field 24 is a three-character code designating the owner of the system. In other words, all labels having corresponding label information starting with the same owner code 24 are considered as potentially relevant to the same system. This avoids labels for one system being confused for labels of another system.

Field 26 is a field up to seven characters long designating a label or item type. For example, if the label is a master label, then field 26 is set to “MT” to indicate a “Master Tag' label. In this embodiment, a master label is a group label. Other potential label types which may be used are OT and GT for order tag label and grandfather tag label, respectively. These label types create a hierarchy in the labels to represent bulk numbers of individual tags. For example, a mining project may issue five shipping containers, packed with hydraulic kits and individual tools. The grandfather tag would be placed on the container, with subservient order or kit tags. One hydraulic kit would comprise six smaller items, hence the ship container is a grandfather tag, the stored hydraulic kits are master label tags and the packaged hydraulic tools within the kits require individual tag labels. If the corresponding label is an item label (such as label 12, FIG. 1), then the field 26 is used as a designator of item type. For example, the field 26 may have a number corresponding to the type of battery to which that label has been applied.

The field 28 is a two-character code corresponding to date. In an embodiment, this is a code comprising a character (A to L corresponding to the month of the year) and a digit (corresponding to the last digit of the year). Therefore, this allows for the storage of the month and year in which the label was created (and may provide a fair indication of the age of the corresponding item).

Field 30 is a three-character field in which a code designating the current location of the item or aggregate is located. Examples of location codes may, by way of example, include MKY for Mackay, TK03 for delivery truck 3, LDV for the LDV commercial vehicle, WHS for warehouse and SHP for shop.

Lastly, field 32 corresponds to a unique serial number for the label concerned.

Although not illustrated in FIG. 3, the label information may further comprise a binary active status field which may be set to active or inactive to indicate whether the item corresponding to that particular label is to considered part of the stock which is being tracked.

It is to be realised that group label will therefore be generated independently of the item labels of the items which form that group. Instead, the identification of which group contains which items will be made via the database as explained below.

FIG. 4 illustrates a location 50 where an embodiment is implemented. The location 50 comprises a warehouse 52 where batteries are stored and a shop 54 where the batteries are stored and sold to consumers. A scanner 56 is located in the warehouse 52 and is therefore associated with the warehouse as a location. In an alternative embodiment the scanner 56 may be associated with a user assigned to work in the warehouse 52 through login information and associated in this manner. In yet a further embodiment, the scanner 56 is tethered to a warehouse wall to prevent movement of the scanner 56 outside of the warehouse.

A shop scanner 58 is similarly associate with the shop as a location. By associating the scanners with their respective locations, it may be possible to determine the location of an item or agglomerate when the corresponding label is scanned by determining a location of that scanner.

FIG. 5 illustrates a networked system 75 for use with embodiments. The system 75 comprises a server 80 having data store 82 and an antenna 84. The server 80 stores a database for tracking items according to embodiments on the data store 82, and uses the antenna 84 for communication.

The system 75 includes three RFID scanners 86, 88 and 90 for scanning RFID tags used as item and aggregate labels in embodiments. Each of the scanners includes a corresponding antenna 92, 94, 96 for wireless communication, for example with the server 80. The scanners 56 and 58 illustrated in FIG. 4 may be in the form of the scanners 86, 88 or 90.

It is to be realised that the depiction of FIG. 5 (as with other Figures) is largely schematic and only certain aspects of the hardware depicted have been illustrated. Furthermore, many other possibilities are possible such as cloud data storage, wired networking etc.

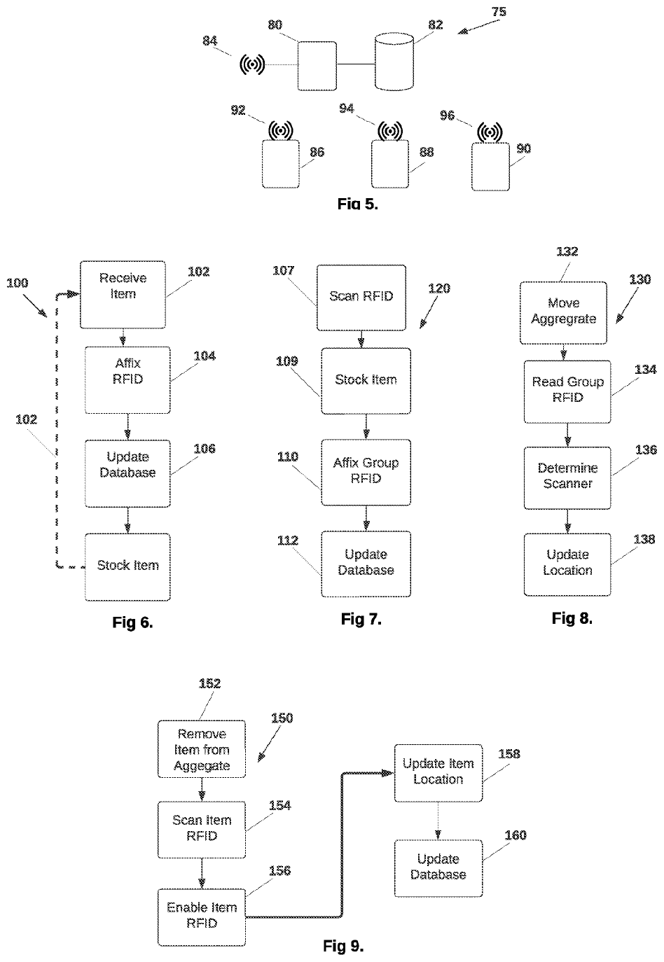

FIG. 6 is a process diagram illustrating a process of forming an aggregate according to an embodiment. FIG. 7 is a process diagram illustrating a process of receiving items and affixing labels. FIG. 8 is a process diagram illustrating a process of moving an aggregate. FIG. 9 is a process diagram illustrating a process of removing an item from an aggregate.

The process of tracking an item according to an embodiment will now be described with reference to FIGS. 6, 7, 8 and 9.

The process of forming an aggregate 100 is illustrated in FIG. 6. This may occur, for example, when batteries are delivered to the warehouse 52 (FIG. 4). At the initial step 102, the item (in this case a battery) is received at the warehouse 52. At the following step, step 104, a glue-backed RFID tag is affixed to the battery ensuring that the tag is not easily removed from the battery. In this embodiment, the RFID tag has been preloaded with the label information indicating the owner identify (field 24, for example “310” indicating that this a maintenance free calcium battery), the battery type (field 26), the date (field 28), the location (field 30) which is in this instance will be the code WHS for warehouse and the battery serial number (field 32).

In a further embodiment, the tag may be programmed with the corresponding label information after being affixed to the battery.

In the following step, step 106, the central database stored on data store 82 of server 80 (FIG. 5) is updated. If the label information has been preloaded on the tag, then step 106 comprises setting the active status of the tag to “active” to indicate that the tag is part of the system and is being actively tracked. In further embodiments, step 106 may comprise writing all data fields to the database.

As indicated by dashed line 105, the process of steps 102, 104 and 106 is repeated for each received item.

Referring to FIG. 7, this illustrates a process 120 for forming an aggregate. In the first step, step 107, the RFID tag of the first item in the aggregate is scanned and the label information corresponding to that tag determined. A list is then generated which, once the aggregate has been formed, will contain the label information of all tags of all items in the aggregate. In the next step, step 109, the item will be stacked. Although the term “stacked” is used, the step involves the process of forming the aggregate. Where the aggregate comprises a stack of items, this will involve the physical act of stacking, but in other embodiments, this may involve placing on a shelf or otherwise physically close to each other. In yet a further embodiment, physical proximity may not be required to form an aggregate.

As indicated by dashed arrow 108, this process is then repeated for each item (in this case batteries) which form the aggregate. Furthermore, in this embodiment, when each item label is scanned to determine the corresponding label information for that item the corresponding RFID tag is disabled. By disabling the tags which form an agglomerate, the number of tags which have to be read to read the group tag may be reduced. However, it is to be realised that the use of the type data field in the label information means that it may not be necessary to disable the labels of the items comprising the agglomerate; when reading or scanning the labels, any label not identified as the type of label being sort may be ignored.

Once the aggregate has been formed (for example, a stack of batteries loaded to a palette), a group RFID tag is affixed to the aggregate. In this embodiment, the stack of batteries is wrapped so that the aggregate retains physical integrity and the group RFID is stuck to the wrap. In this embodiment, the label information for the group RFID contains the location of the aggregate where the group is stored, but in further embodiments the location of the group RFID may be established by using the scanner associated with the location, as described in further detail below.

At step 112, the database is updated to indicate that each of the items (identified by the corresponding label information read during the scanning process) comprises part of this aggregate.

FIG. 8 illustrates a process of moving an aggregate (such as the aggregate formed in the process of FIG. 7) from one location to another. At step 132 the aggregate is moved from one location to another. By way of example, it is considered that the aggregate is moved from the warehouse 52 of FIG. 4 to the shop 54. Once the aggregate has been moved to the destination (the shop 54 in this example), the scanner associated with that location is used to scan the group RFID affixed to the aggregate (step 134). With reference to FIG. 4, the scanner 58 is used to scan the group RFID of the aggregate. This process of determining the scanner used then occurs at step 136.

Since the location of the scanner is known and the scanner is associated with this location, in this case the shop 54, it is known that the location of the aggregate is the shop 54, the label information for the group label is updated accordingly by setting field 30 to “SHP” showing that the location of the aggregate is now the shop 54.

In an embodiment, a group label is associated with only one location. This may be, for example, if the group label corresponds to a storage location in a warehouse. Then, if the aggregate is moved to a new location, a new group label is applied to the aggregate. In the example where the labels are programmable tags, then the tag may be reprogrammed, instead of physically applying a new label.

FIG. 9 illustrates the process 150 for removing an item from an aggregate. At step 152 the item (battery) to be removed is physically removed from the aggregate. Then, at step 154, the item's RFID is read to determine the serial number of the item being removed. At step 156 the item's RFID tag is enabled (where necessary) and, at step 158 the item's location may be updated.

It is to be realised that the item's location need only be updated where the scanner used to read the item RFID corresponds to a location different from the location currently associated with the group RFID. For example, if the item is moved to a different location as part of removing the item from the aggregate, then when the item RFID tag is read, it will be determined that the location of the scanner reading the tag has a location different from the location currently set for that item (though the location of the corresponding group tag), and the new location for that item will then be set at step 158, if necessary.

At step 160 the database is updated to remove the item from the items associated with the aggregate from which the item has been removed and to update any entries associated with the item itself to reflect that the item is no longer part of the agglomerate. Advantageously, this step of updating the information relating to the aggregate and the corresponding group RFID occurs automatically when the item RFID is scanned by a scanner associated with a different location than the current location of the group RFID. If the moved item now forms part of a new aggregate then information corresponding to the new group tag will be updated at step 160.

In general then, a location for a particular item may be determined by querying the database according to the item's serial number. The database will then determine the location of that item by either determining the location code for the particular item (if the item is not part of an aggregate) or by determining the location code for the label information of the corresponding aggregate (if the item is part of an aggregate).

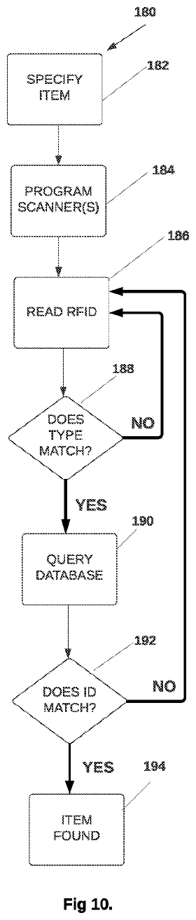

FIG. 10 illustrates a process 180 for finding a particular item within range of a scanner. It is to be noted that, but appropriate planning and location of scanners it is possible to have all items to be tracked within range of at least one scanner.

At step 182 a user specifies the item that is being sought. The system queries the database to determine what the item type is of the sought item and whether that item is part of an aggregate or not. In either case, the system will determine a label or type code corresponding to the information stored at field 30 of the label information (see FIG. 3).

Then, at step 184, each scanner is instructed to seek the determined label or type code. Each scanner will then scan all labels within range of that scanner and for each label (in this embodiment an RFID) scanned will determine the label information (step 186). The scanner will then compare the determined label information to the specified item or label type (step 188). If the label or type does math the specified information, then the scanner will instruct the server (80, FIG. 5) to query the database (step 190) with the item code determined from the read label to determine if the read label corresponds to the sought item (step 194).

If the read item does correspond to the sought item then the item is found (step 194) and the process terminates.

However, if at step 188 the determined item or label type does not match the specified label or item type, or at step 192 the read item does not match the sought item, the process will return to step 186 and read the next RFID.

It is to be realised that this process may allow the scanner to carry out a portion of the seek process and this may avoid unnecessary calls to the server and the database.

A further example involves the movement of batteries from a warehouse to a shop.
Bulk stock arrives (50 batteries), RFID labels attached, scanned by the warehouse handset (W1)—location code updated in RFID tag table (at inception MKWH1 is the designated location code in this example).

Warehouse staff move and allocate (load) all fifty batteries to Master Tag WC1 (warehouse column 1)
The RFID tag table now holds a pointer referring all 50 batteries to WC1. Any further stock scans with scanner W1 will confirm that the same fifty batteries remain present in the Mackay warehouse.
Two of the WC1 batteries are physically moved to the shop: at next shop stock-check, scanner SHP1 detects them and alerts, recognising an unexpected warehouse location code (WC1) for two batteries within its associated location.
The staff member uses the locate function to scan and confirm two serialised, specific batteries are actually present, prompting the user with the ability to confirm a stock transfer to the shop.
The location code field for these two specific batteries is amended to SHP (code corresponding with the shop). Both battery IDs are removed from the WC1 table and appended to the shop Master Tag table. WC1's table now lists 48 specific batteries, the shop's table lists an additional two batteries and each battery's location code is also updated individually.

As used herein, the term “device” shall not be limited to meaning a unitary entity, but covers both a unitary entity and an entity comprising distinct components whether manually removable, or not.

It is to be understood that, if any prior art publication is referred to herein, such reference does not constitute an admission that the publication forms a part of the common general knowledge in the art, in Australia or any other country.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments. Similarly, the word “device” is used in a broad sense and is intended to cover the constituent parts provided as an integral whole as well as an instantiation where one or more of the constituent parts are provided separate to one another.

1. A method for tracking a geographical location of a designated item, the method comprising:
collecting a plurality of items including the designated item to form an aggregate, wherein each of the plurality of items, including the designated item, has a corresponding item label, and the aggregate is formed in such way to obscure one or more of the item labels;
applying a group label to the aggregate;
reading the group label with a first scanner;
associating a first location with the first scanner;
ascribing the first location to the group label; and
ascribing the first location to the designated item.

2. The method according to claim 1 wherein the one or more of the item labels is an RFID tag and wherein the group label is an RFID tag.

3. The method according to claim 1 wherein the method further comprises associating a second location to a second scanner; scanning the group label with the second scanner and ascribing the second location to the designated item. Preliminary Amendment

4. The method according to claim 1 further comprising removing a moved item from the aggregate; scanning an item label associated with the moved item and updating information associated with the group label.

5. The method according to claim 4 further comprising the step of updating information associated with a further group label after moving a moved item.

6. The method according to claim 5 wherein the step of moving the moved item comprises updating the location descriptor for a label associated with the moved item.

7. The method according to claim 1 wherein each item label and each group label have label information associated therewith.

8. The method according to claim 6 wherein the label information comprises one or more of the following: owner identification, label type, item type, creation date, location designator and serial number.

9. The method according to claim 1 wherein the step of ascribing the first location to the group label and/or the step of ascribing the first location to the designated item may comprise updating a location designator for label information associated with the group label and/or the designated item.

10. The method according to claim 7 wherein the label information comprises data stored in or on the label associated with the item. Preliminary Amendment

11. The method according to claim 10 wherein the label information further comprises an active status.

12. The method according to claim 10 wherein updating the label information comprises storing new data in or on the label.

13. The method according to claim 1 further comprising scanning a group label or an item label wherein, when scanning a label, a label type is determined from the label information and the scanner determines whether the label type matches a sought label type.

14. The method according to claim 1 wherein the step of collecting a plurality of items including the designated item to form an aggregate includes the step of disabling each of the item labels of each of the plurality of items.

15. A system for tracking a geographical location of a designated item, the system comprising:
a plurality of items including the designated item collected to form an aggregate, wherein each of the plurality of items, including the designated item, has a corresponding item label, and the aggregate is formed in such way to obscure one or more of the item labels;
a group label applied to the aggregate;
a first scanner associated with a first location;
a processor connected to memory and machine readable instructions loaded to the memory to cause the processor to:
read the group label with the first scanner;
associate a first location with the first scanner;
ascribe the first location to the group label; and
ascribe the first location to the designated item.

16. The system according to claim 15 further comprising a second scanner associated with a second location and the processor may be adapted to ascribe the second location to the designated item when the group label is scanned with the second scanner.

17. The system according to claim 15 wherein the system is adapted to update information associated with the group label when a moved item is removed from the aggregate and an item label associated with the moved item is scanned with a scanner.

18. A method of seeking a designated item among a plurality of items wherein each item, including the designated item, has a corresponding item label, each item label having information stored thereon wherein the information stored on each label identifies the type of label and/or the type of item, the method comprising:
providing a first scanner and associating a first location with the first scanner
reading a plurality of labels with the first scanner;
wherein the scanner is adapted to determine the type of label and/or the type of item based on reading the corresponding label and, only if the type of label and/or the type of item matches the type of label and/or the type of label of the designated item, querying a remote server to determine whether the item or label matches the designated item.

19. The method according to claim 18 wherein the designated item is included in an aggregate of a plurality of items, wherein the plurality items has a group label associated therewith.

20. The method according to claim 19 wherein the item label corresponding to the designated item is disabled while the designated item forms part of the aggregate.

21. The method according to claim 18 where the item forms part of an aggregate, the method comprises the steps of programming the scanner to seek a group label and querying the remote server when the scanner determines that a read label is a group label and not querying the remote server when the scanner determines that the read label is not a group label or is an item label.

22. The method according to claim 18 where the item does not form part of an aggregate, the method may comprise the steps of programming the scanner to seek an item type and querying the remote server when the scanner determines that a read label corresponds to a specified item type and not querying the remote server when the scanner determines that the read label does not correspond to the specified item type.
